(19) United States
(12) Patent Application Publication
(10) Pub. No.: US 2026/0179319 A1
(43) Pub. Date: Jun. 25, 2026

(54) GAUSSIAN SIMULTANEOUS LOCALIZATION AND MAPPING

(71) Applicants: XILINX, INC., SAN JOSE, CA (US); Xilinx Technology Bejing Limited, Beijing (CN)

(72) Inventors: RenWu Li, Beijing (CN); Emad Barsoum, Sammamish, WA (US); Wenjing Ke, Beijing (CN); Dong Li, Beijing (CN); Lu Tian, Beijing (CN)

(21) Appl. No.: 18/987,093

(22) Filed: Dec. 19, 2024

(51) Int. Cl. G06T 17/05; G06T 7/20

(52) U.S. Cl. CPC G06T 17/05; G06T 7/20; G06T 2207/30241

(57) ABSTRACT

A processing system is configured to generate a three-dimensional (3D) Gaussian map representing at least a portion of an environment surrounding the processing system. For example, a capture device of the processing device first captures a set of frames each including color data. The processing system then implements a visual odometry (VO) tracking model which samples patches from this set of frames so as to generate a point cloud and pose data representing the location and orientation of the patches within the environment. Further, the processing system implements a Gaussian Mapping model that generates a set of Gaussians from the point cloud which the processing system then uses to populate a 3D Gaussian map.

### BACKGROUND

Certain platforms, such as autonomous vehicles, navigate environments by implementing Gaussian-based simultaneous localization and mapping (SLAM) techniques that generate a three-dimensional (3D) representation of environment surrounding the platform. To implement these SLAM techniques, the platforms include one or more cameras that capture images of the environment and one or more depth sensors that measure the distance between the platform and objects in the environment. Based on these images and measurements of the depth sensors, the platforms generate a 3D Gaussian map representing the environment. For example, the platforms generate a 3D Gaussian map that includes Gaussians representing objects and structures within the environment.

### BRIEF DESCRIPTION OF THE DRAWINGS

The present disclosure may be better understood, and its numerous features and advantages are made apparent to those skilled in the art by referencing the accompanying drawings. The use of the same reference symbols in different drawings indicates similar or identical items.

FIG. 1 is a block diagram of a processing system configured to implement Gaussian simultaneous localization and mapping (SLAM) using captured frames with red, green, blue (RBG) data, in accordance with some implementations.

FIG. 2 is a flow diagram of an example operation for initializing a three-dimensional (3D) Gaussian map based on captured frames with RGB data, in accordance with some implementations.

FIG. 3 is a flow diagram representing an example operation for updating a 3D Gaussian map based on captured frames with RGB data, in accordance with some implementations.

FIG. 4 is a flow diagram of an example method for implementing a Gaussian SLAM operation based on a captured frames with RGB data, in accordance with some implementations.

### DETAILED DESCRIPTION

Systems and techniques disclosed herein include a processing system configured to implement a Gaussian SLAM operation based on captured frames that include pixel data (RGB data, YUV data). For example, the processing system is implemented in a robotic platform, autonomous vehicle (e.g., autonomous car, van, truck, drone, ship, submersible, unmanned aerial vehicle (UAV)), autonomous mapping platform, or the like and is configured to generate a 3D representation (e.g., 3D Gaussian map) of the environment around the processing system based on captured frames each representing a respective view of a scene indicating the environment. These captured frames, for example, include frames captured by a capture device (e.g., camera) that include pixel values (e.g., RGB values) for each pixel of the frame. Such captured frames are also referred to herein as an “RGB frame”.

To generate the 3D representation of the environment associated with these RGB frames, the processing system includes a processor that includes at least one central processing unit (CPU), at least one accelerator unit (AU), or both configured to perform a Gaussian SLAM operation based on one or more RGB frames. For example, this Gaussian SLAM operation first includes the processor implementing a visual odometry (VO) tracking model. This VO tracking model, for example, is configured to determine the position and movement of a platform (e.g., robotic platform, autonomous vehicle, autonomous mapping platform) within an environment and includes one or more deep-learning machine-learning models, unsupervised machine-learning models, supervised machine-learning models, reinforcement learning models, or any combination thereof configured to implement monocular VO tracking. As an example, the VO tracking model includes a Deep Patch VO model. The VO tracking model is configured to receive the RGB frames as inputs and provide a point cloud (e.g., sparce point cloud) and pose data as outputs based on the RBG values indicated in the RGB frames and the parameters (e.g., weights) of the VO tracking model. For example, while implementing the VO tracking model, the processor first determines pose data associated with each RGB frame provided as an input. Such pose data, for example, represents the position and orientation of the capture device within the scene represented by a corresponding RGB frame. Further, the process includes the processor sampling a predetermined number of patches from each RGB frame provided as an input and parameterizes the patches so that each patch indicates an inverse depth and the positioning (e.g., location and orientation) the patch within the scene. The processor then builds a point cloud (e.g., sparse point cloud) indicating the positions (e.g., tie points) and inverse depths of patches that are common within (e.g., shared by) two or more RGB frames.

Additionally, the processor is configured to implement a Gaussian mapping model that generates a 3D Gaussian map representing the environment based on the point cloud and pose data generated by the VO tracking model and based on the parameters of Gaussians generated by the Gaussian mapping model. This Gaussian mapping model, for example, includes one or more deep-learning machine-learning models, unsupervised machine-learning models, supervised machine-learning models, reinforcement learning models, or any combination thereof configured to receive a point cloud and pose data from the VO tracking model as inputs and provide a 3D Gaussian map as an output. For example, the Gaussian mapping model includes the processor first initializing a 3D Gaussian map by back-projecting the centers of patches indicated in the point cloud into a global point cloud indicating coordinates for the centers of the patches in a world coordinate system. Using this global point cloud, the processor generates a set of Gaussians and initializes (e.g., populates) a 3D Gaussian map using this set of Gaussians. Each of these Gaussians, for example, include data (e.g., a vector) indicating a position within the world coordinate system, a covariance, one or more RGB values, orientation, 3D scale, and a transparency value (e.g., an alpha). After initializing the 3D Gaussian map, the processor, for each successive point cloud and set of pose data received from the VO tracking model, determines whether each point in a received point cloud is redundant when compared to the Gaussians of the initialized 3D Gaussian map. As an example, for each point in a successive point cloud, the processor determines the distance between the point and the mean (e.g., center) of each Gaussian in the 3D Gaussian map. Based on the respective distance between the point and the mean of each Gaussian in the 3D Gaussian map not exceeding a threshold value, the processor determines that the point is redundant and rejects the point. That is, the processor does not generate a Gaussian for the point. Further, based on the respective distance between the point and the mean of one or more Gaussians in the 3D Gaussian map meeting or exceeding the threshold value, the processor determines that the point is not redundant. The processor then based on the point, generates a corresponding Gaussian. After generating the Gaussian, the processor inserts the Gaussian into the 3D Gaussian map.

Further, the Gaussian mapping model includes the processor performing one or more post-processing techniques on the generated 3D Gaussian map to help improve the clarity, accuracy, or both of the 3D Gaussian map. For example, the Gaussian mapping model also includes the processor performing a Gaussian densification operation on the generated 3D Gaussian map during which the processor densifies the Gaussians of the 3D Gaussian map based on a pixel rendering gradient. As an example, during a Gaussian densification operation, the processor clones, splits, or both Gaussians within the 3D Gaussian map that have a pixel rendering gradient equal to or above a predetermined gradient threshold. By performing such a densification operation, the clarity of certain smooth areas rendered from the 3D Gaussian map are enhanced. Additionally, the processor performs a planar regulation operation during which the processor tunes the Gaussian mapping model based on a rendered frame. That is, the processor modifies one or more parameters of Gaussians within the 3D Gaussian map based on a rendered frame. As an example, the processor first rasterizes the Gaussians in the 3D Gaussian map to generate a rendered frame representing the environment. The processor then compares this rendered frame to a corresponding RGB frame that was provided as an input to determine a loss value based on the photometric loss between the rendered frame and the corresponding RGB frame. Using this loss value, the processor modifies one or more parameters of Gaussians within the Gaussian map to reduce the loss value.

In this way, the processing system is configured to generate a 3D Gaussian map using only the RGB values of the input RGB frames. Because the processing system only uses the RGB values to generate a 3D Gaussian map, the processing system requires fewer components when compared to a processing system implementing conventional SLAM techniques which reduces the size, cost, and complexity of the processing system. For example, some conventional SLAM techniques generate 3D Gaussian maps using depth data collected from one or more depth sensors. However, only using RGB values to generate a 3D Gaussian map means that this depth data does not need to be collected, allowing the processing system to function without depth sensors and reducing the size, cost, and complexity of the processing system. Further, by only using the RGB values of frames to generate a 3D Gaussian map, the processing system more quickly generates the 3D Gaussian map when compared to conventional SLAM techniques as the collection of depth data is not required.

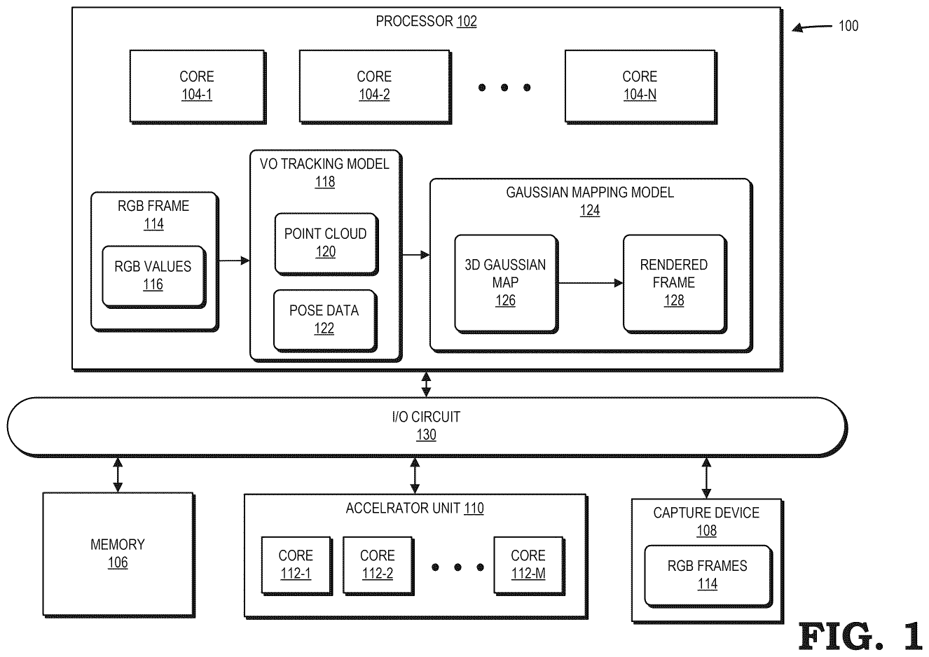

FIG. 1 presents a processing system 100 configured to perform a Gaussian SLAM operation using RGB data, in accordance with implementations. Such a processing system 100, for example, is implemented within a robotic platform, autonomous vehicle (e.g., autonomous car, van, truck, drone, ship, submersible, UAV), autonomous mapping platform, or the like and is configured to capture one or more frames (e.g., RGB frames 114) each representing a view of the environment around the processing system 100. As an example, the processing system 100 includes or is otherwise connected to a capture device 108 configured to capture one or more frames such that the frames include data representing the environment around the processing system 100. For example, capture device 108 includes a camera, video recorder, or both configured to capture frames that include one or more RGB values 116 (e.g., RGB, YUV, or other color values) for each pixel of the frame. Frames captured by capture device 108 and including one or more RGB values 116 for each pixel of the frame are represented in FIG. 1 as “RGB frames” 114. Based on these RGB frames 114, the processing system 100 is configured to generate a 3D Gaussian map 126 which includes a 3D representation of the environment around the processing system 100 system, the location of the processing system 100 within the environment, or both. As an example, the 3D Gaussian map 126 includes one or more Gaussians which each include data (e.g., a vector) indicating a 3D position (e.g., position within a world coordinate system), a covariance, one or more RGB values, orientation, and a transparency value (e.g., an alpha) within the environment.

To generate the 3D Gaussian map 126 from the RGB frames 114, the processing system 100 includes memory 106 or another storage device implemented using a non-transitory computer-readable medium, for example, a dynamic random-access memory (DRAM). In some implementations, memory 106 is implemented using other types of memory including, for example, static random-access memory (SRAM), nonvolatile RAM, and the like. Further, memory 106, according to some implementations, includes an external memory to the processing units implemented in the processing system 100. In some implementations, memory 106 (e.g., a storage device) is configured to store one or more RGB frames 114 captured, for example, by capture device 108. Additionally, the processing system 100 includes processor 102 configured to implement a Gaussian SLAM operation using one or more RGB frames 114. To execute this Gaussian SLAM operation, processor 102 includes one or more processor cores 104 configured to execute instructions concurrently or in parallel for the Gaussian SLAM operation. Though the example implementation presented in FIG. 1 shows processor 102 as including three processing cores (104-1, 104-2, 104-N) representing an N integer number (where N>0) of processor cores, in other implementations, processor 102 includes any non-zero integer number of processor cores 104. According to some implementations, processor 102 is implemented as a CPU having any number of processor cores 104 each configured to concurrently execute two or more threads. According to other implementations, processor 102 is implemented as an AU including one or more processor cores 104 operating as one or more compute units (e.g., groups of single instruction, multiple data (SIMD) units, vector registers, scalar registers, arithmetic logic units (ALUs)) that perform the same operation on different data sets. Such an AU, for example, includes one or more processors, coprocessors, graphics processing units (GPUs), general-purpose GPUs (GPGPUs), non-scalar processors, highly parallel processors, artificial intelligence (AI) processors, neural processing units (NPUs), inference engines, machine-learning processors, other multithreaded processing units, scalar processors, serial processors, programmable logic devices (e.g., field-programmable gate arrays (FPGAs)), or any combination thereof.

In implementations, to implement a Gaussian SLAM operation, processor 102 first implements a VO tracking model 118 configured to generate a point cloud 120 (e.g., sparse point cloud) and pose data 122 based on one or more RGB frames 114 and the parameters of the VO tracking model 118. This VO tracking model 118, for example, includes one or more deep-learning machine-learning models, unsupervised machine-learning models, supervised machine-learning models, reinforcement learning models, or any combination thereof configured to implement monocular VO tracking. As an example, the VO tracking model 118 includes one or more Deep Patch VO models. When implementing the VO tracking model 118, processor 102 first determines pose data 122 for each RGB frame 114 that was provided as an input. Such pose data 122, for example, represents the location and orientation of the capture device 108 relative to the scene represented by the RGB frame 114. Further, processor 102 is configured to randomly or pseudo-randomly select one or more patches at different locations from each RGB frame 114 provided as an input. These patches, for example, include groups of pixels that include a predetermined number of pixels in a first direction (e.g., x-direction) and a predetermined number of pixels in a second direction (e.g., y-direction). According to some implementations, each patch sampled from the RGB frames 114 includes the same number of pixels in the first and second directions while in other implementations each patch sampled has a different number of pixels in the first and second directions. Additionally, in some implementations, while implementing the VO tracking model 118, the processor 102 is configured to sample a predetermined number of patches from each RGB frame 114 provided as an input. Further, processor 102 is configured to parameterize each patch such that each patch indicates a set of homogeneous coordinates indicating an inverse depth and a location and orientation of the patch within the RGB frame 114 (e.g., location within a corresponding frame 114). This inverse depth represents the reciprocal of the distance from a point in the scene representing the environment to the capture device 108. For example, this inverse depth provides a measure of depth where larger values correspond to points closer to the capture device and smaller values correspond to points further away.

From these sampled patches, processor 102 constructs a patch graph that includes edges indicating the trajectory of patches between two or more RGB frames 114. According to some implementations, processor 102 is configured to refine the inverse depth for one or more patches and the pose data 122 for one or more RGB frames 114 by implementing a differential bundle adjustment. For example, based on the patch graph, processor 102 implements a recurrent network configured to predict trajectory updates for the patches and confidence weights for each edge in the patch graph so as to minimize one or more values (e.g., Mahalanobis distances). In implementations, processor 102 is configured to update the inverse depth and pose data 122 for each patch based on each successive RGB frame 114 received by the VO tracking model 118. From the inverse depth for each patch and the pose data 122, processor 102 generates a point cloud 120 (e.g., sparse point cloud) representing the positions (e.g., tie points) and inverse depths of patches that are common within (e.g., shared by) two or more RGB frames 114 input to the VO tracking model 118.

After generating a point cloud 120 and pose data 122 from one or more RGB frames 114, processor 102 implements a Gaussian mapping model 124 configured to generate a 3D Gaussian map 126 based on the point cloud 120, pose data 122, and the parameters of the Gaussian mapping model 124. The Gaussian mapping model 124 includes, for example, one or more deep-learning machine-learning models, unsupervised machine-learning models, supervised machine-learning models, reinforcement learning models, or any combination thereof configured to receive a point cloud 120 and pose data 122 representing one or more sampled patches as inputs and provide a 3D Gaussian map as an output based on the parameters of the model. As an example, while implementing the Gaussian mapping model 124, processor 102 is configured to initialize a 3D Gaussian map 126 by back-projecting the patches indicated in the point cloud 120 into a global point cloud. That is, based on the inverse distances indicated in the point cloud 120, processor 102 back-projects the center of the patches indicated in the point cloud 120 to generate a global point cloud representing positions of the patches within a world coordinate system. Using the global point cloud, processor 102 generates a set of Gaussians each indicating the position within the world coordinate system, a covariance, one or more RGB values, orientation, and a transparency within the environment. Processor 102 then initializes (e.g., populates) a 3D Gaussian map 126 using the set of Gaussians. After initializing the 3D Gaussian map 126, in implementations, processor 102 is configured to update the 3D Gaussian map 126 based on subsequent RGB frames 114 provided as inputs to the VO tracking model 118. For example, based on the subsequent RGB frames 114, processor 102 implements VO tracking model 118 to generate a subsequent point cloud 120 and pose data 122. Processor 102 then determines whether each point indicated in the point cloud 120 is redundant when compared to the Gaussians in the 3D Gaussian map 126. For example, processor 102 first determines the distance between the point and the mean (e.g., center) of each Gaussian in the 3D Gaussian map 126. Based on the respective distance between the point and the mean of each Gaussian of the 3D Gaussian map 126 not exceeding a predetermined threshold, processor 102 rejects the point and does not generate a corresponding Gaussian. Further, based on the respective distance between the point and the mean of one or more Gaussians of the 3D Gaussian map being equal to or greater than the predetermined threshold, processor 102 back-projects the point and generates a corresponding Gaussian based on the back-projected point. Processor 102 then inserts this Gaussian into the 3D Gaussian map 126. By only inserting Gaussian generated from points determined not to be redundant, the number of Gaussians generated by the processing system 100 is reduced which decreases the time needed to update the 3D Gaussian map 126.

According to implementation, Gaussian mapping model 124 further includes processor 102 performing one or more post-processing operations on the 3D Gaussian map 126. For example, while implementing Gaussian mapping model 124, processor 102 is configured to perform one or more densification operations to help enhance the clarity of the 3D Gaussian map 126. During such a densification operation, processor 102 is configured to determine a pixel rendering gradient for each Gaussian based on the RGB values rendered from the Gaussians. Based on the pixel rendering gradient for a Gaussian being equal to or exceeding a predetermined threshold value, processor 102 splits or clones the Gaussian. As an example, based on the 3D scale of a Gaussian, processor 102 splits or clones the Gaussian in response to the pixel rendering gradient for a Gaussian being equal to or exceeding a predetermined threshold value. By performing the densification operation on the 3D Gaussian map 126, the clarity of smooth-colored regions rendered from the 3D Gaussian map 126 are enhanced. Further, in implementations, Gaussian mapping model 124 includes processor 102 tuning the Gaussian mapping model 124 by performing a planar regularization operation. During this planar regularization operation, processor 102 first generates a rendered frame 128 from the 3D Gaussian map 126 such that the rendered frame 128 represents a view of the environment around processing system 100 and includes one or more RGB values for each pixel of the rendered frame 128. Processor 102 then compares the rendered frame 128 to a corresponding RGB frame 114 (e.g., the RGB frame 114 representing the same view of the environment as the rendered frame 128). From this comparison, processor 102 determines a loss value representing the standard photometric loss between the RGB frame 114 and the rendered frame 128. After determining this loss value, processor 102 modifies one or more parameters of the Gaussians in the 3D Gaussian map so as to reduce the loss value. In this way, processor 102 is configured to produce a more accurate 3D Gaussian map 126.

By generating the 3D Gaussian map 126 using only the RGB values 116 of captured frames, the processing system 100 requires fewer components when compared to processing systems that implement conventional SLAM techniques. For example, some conventional SLAM techniques require generating 3D Gaussian maps with depth data collected from one or more depth sensors implemented in the processing system which increases the size, cost, and complexity of these systems. However, only using RGB values 116 to generate a 3D Gaussian map 126 obviates the need for such depth data, allowing the processing system 100 to function without depth sensors which reduces the size, cost, and complexity of the processing system when compared to processing system implementing convention Gaussian SLAM techniques. Further, by only using the RGB values 116 of captured frames to generate a 3D Gaussian map 126, the processing system 100 is enabled to more quickly generate the 3D Gaussian map 126 when compared to conventional SLAM techniques as the collection of depth data is not required.

According to implementations, processing system 100 includes accelerator unit AU 110 configured to perform one or more instructions, operations, or both for VO tracking model 118, Gaussian mapping model 124, or both. AU 110, for example, is configured to operate as one or more vector processors, coprocessors, GPUs, GPGPUs, non-scalar processors, highly parallel processors, AI processors, NPUs, inference engines, machine-learning processors, other multithreaded processing units, scalar processors, serial processors, programmable logic devices (e.g., FPGAs), or any combination thereof. To perform operators, instructions, or both for VO tracking model 118, Gaussian mapping model 124, or both, AU 110 implements a plurality of processor cores 112-1, 112-2, 112-M that execute instructions concurrently or in parallel. In some implementations, one or more of the processor cores 112 each operate as one or more compute units (e.g., groups of single instruction, multiple data (SIMD) units, vector registers, scalar registers, ALUs) that perform the same operation on different data sets. Though in the example implementation illustrated in FIG. 1, AU 110 includes three processor cores (112-1, 112-2, 112-M) representing an M integer number of cores (where M>0), the number of processor cores 112 implemented in AU 110 is a matter of design choice. As such, in other implementations, AU 110 can include any non-zero integer number of processor cores 112.

In some implementations, to enable communication between processor 102 and one or more other components (e.g., AU 110, memory 106, capture device 108) of processing system 100, processing system 100 includes input/output (I/O) circuit 130. I/O circuit 130 includes, for example, one or more busses, switches (e.g., PCI switches), data fabrics, queues, buffers, or the like. As an example, in implementations, I/O circuit 130 is configured to connect capture device 108 to processor 102, memory 106, or both. As another example, I/O circuit 130 is configured to connect a command processor of AU 110 (now shown for clarity) to one or more processor cores 104 of processor 102, memory 106, or both.

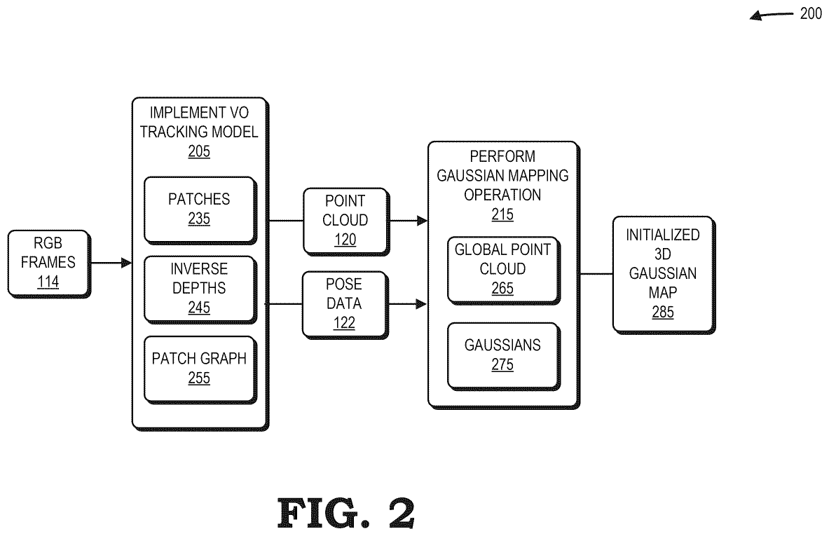

Referring now to FIG. 2, an example operation 200 for initializing a 3D Gaussian map using RGB frames is presented, in accordance with implementations. In implementations, example operation 200 is implemented by processor 102, AU 110, or both. At block 205 of example operation 200, processor 102 implements VO tracking model 118 to generate a point cloud 120 and pose data 122. For example, at block 205, processor 102 first provides one or more RGB frames 114 to VO tracking model 118 as an input. Processor 102 then determines pose data 122 for each RGB frame 114 provided as an input such that the pose data 122 indicates the location and orientation of the capture device 108 relative to the scene represented by a corresponding RGB frame 114. Further, processor 102 samples a predetermined number of patches 235 from randomly or pseudo-randomly selected locations of each RGB frame 114. Each patch 235, for example, includes a first number of pixels in a first direction (e.g., x-direction) and a second number of pixels in a second direction (e.g., y-direction). According to some implementations, one or more patches 235 include the same number of pixels in the first and second directions while in other implementations one or more patches 235 includes a different number of pixels in the first and second directions. Still referring to block 205, example operation 200 includes processor 102 parameterizing the sampled patches 235 such that the patches 235 are each represented by a set of homogeneous coordinates that includes an inverse depth 245 of the patch 235. This inverse depth 245, for example, represents the reciprocal of the distance from a point in the patch 235 to the capture device 108. That is, the reciprocal of the distance from a point in the scene representing the environment as indicated by the patch 235 to the capture device 108. According to implementations, an inverse depth 245 having greater values corresponds to points closer to the capture device 108 and smaller values correspond to points further away from the capture device 108. As an example, processor 102 parameterizes the patches 235 so they are represented by the following equation:

$${P}_{k}^{i} = {[ u , v , 1 , d ]}^{T} \qquad [ EQ 1 ]$$

wherein P represents a patch 235, i indicates a corresponding RGB frame, k indicates a corresponding sample, u represents a position along a first axis (e.g., x-axis) in a corresponding RGB frame 114 (e.g., position within a corresponding frame), v represents a position along a second axis (e.g., y-axis) in a corresponding RGB frame 114, and d represents the inverse depth 245 of the patch 235.

Still referring to block 205, the VO tracking model 118 further includes processor 102 generating a patch graph 255 based on the sampled patches 235. Such a patch graph 255, for example, represents the parameterized patches 235 and includes edges each indicating a trajectory of a corresponding patch 235 through one or more RGB frames 114 input to the VO tracking model 118. As an example, the edges of the patch graph each indicate the trajectory of a corresponding patch 235 from a temporally first (e.g., first captured) RGB frame 114 input to the VO tracking model 118 and one or more temporally successive (e.g., later captured) RGB frames 114 input to the VO tracking model 118. In some implementations, processor 102 is configured to determine such trajectories based on the following equation:

$${P}_{k}^{j ← i} ∼ {KT}_{j} {T}_{i}^{- 1} {K}^{- 1} {P}_{k}^{i} \qquad [ EQ 2 ]$$

wherein

$${P}_{k}^{j ← i}$$

represents the trajectory of a patch 235 from a first RGB frame 114 to a second RGB frame 114, i indicates the first RGB frame 114, j indicates the second RGB frame 114, k represents the kth sampled patch, K represents the camera intrinsic matrix, and T represents pose data 122 for an RGB frame 114.

According to some implementations, processor 102 is configured to refine the inverse depths 245 and pose data 122 associated with the patches 235 indicated by the patch graph 255 according to a differentiable bundle adjustment. As an example, processor 102 is configured to implement a recurrent network configured to predict patch trajectory updates (e.g., δₖⱼ∈ [symbol] ) and confidence weights (e.g., Σₖⱼ∈ [symbol] ) for each edge in the patch graph 255 so as to reduce one or more certain distances (e.g., Mahalanobis distance). As an example, in some implementations, processor 102 is configured to refine the inverse depths 245 and pose data 122 associated with the patches 235 based on the following equation:

$${\sum }_{( i , j , k ) ∈ ε} {‖ {KT}_{j} {T}_{i}^{- 1} {K}^{- 1} \hat{P} {k}^{i} - \hat{P} {k}^{j ← i} ‖}_{{\sum }_{kj}}^{2} \qquad [ EQ 3 ]$$

wherein i represents a first RGB frame 114, j represents a second RGB frame 114, k represents a corresponding sample, K represents the camera intrinsic matrix, T represents pose data 122 for an RGB frame 114, and P represents a patch 235. In implementations, for one or more successive RGB frames 114 received as an input by the VO tracking model 118, processor 102 is configured to update the inverse depths 245 of one or more patches 235 indicated by the patch graph 255 based on the successive RGB frames 114.

From the patch graph 255, processor 102 is configured to generate a point cloud 120 representing the positioning (e.g., location and orientation) and inverse depths 245 of the patches 235 indicated in the patch graph 255 that are common within (e.g., shared by) two or more RGB frames 114 input to the VO tracking model 118. Referring now to block 215, processor 102 is configured to implement the Gaussian mapping model 124 which is configured to initialize a 3D Gaussian map 126 based on the point cloud 120, pose data 122, and the parameters of the Gaussian mapping model 124. For example, at block 215, processor 102 first back projects the centers of the patches 235 indicated in the point cloud 120 to form a global point cloud 265 that indicates coordinates for the centers of the patches 235 in a world coordinate system. As an example, the centers of the patches 235 are back projected according to the following equation:

$$P = \{ {T}_{i}^{- 1} {K}^{- 1} {\hat{P}}_{k}^{i} \vert i \leq N , k \leq K \} \qquad [ EQ 4 ]$$

wherein P represents the initialized global point cloud 265, T represents pose data 122 for a corresponding RGB frame 114, K represents the camera intrinsic matrix, i indicates a corresponding RGB frame 114, k represents a corresponding sample, P represents a patch 235, and N represents the number of RGB frames 114 provided as an input to the VO tracking model 118.

From this global point cloud 265, processor 102 is configured to determine a set of Gaussians 275 each including data (e.g., a vector) indicating a position within the world coordinate system, a covariance, one or more RGB values, orientation, 3D scale, and a transparency. According to implementations, processor 102 is configured to determine a number of Gaussians 275 based on the number of samples and number of RGB frames 114 provided to the VO tracking model 118. For example, in implementations, processor 102 determines a number of Gaussians 275 based on the following equation:

$$\vert G \vert = N \times K \qquad [ EQ 5 ]$$

wherein G represents the 3D Gaussian map, N represents the number of RGB frames 114 input into VO tracking model 118, and K represents the number of samples used to generate patches 235. After determining this number of Gaussians 275, processor 102 then initializes (e.g., populates) a 3D Gaussian map 126 based on these Gaussians 275 to produce an initialized 3D Gaussian map 285. According to implementations, after producing the initialized 3D Gaussian map 285, processor 102 is configured to perform one or more post processing operations such as a densification operation, planar regulation operation, or both.

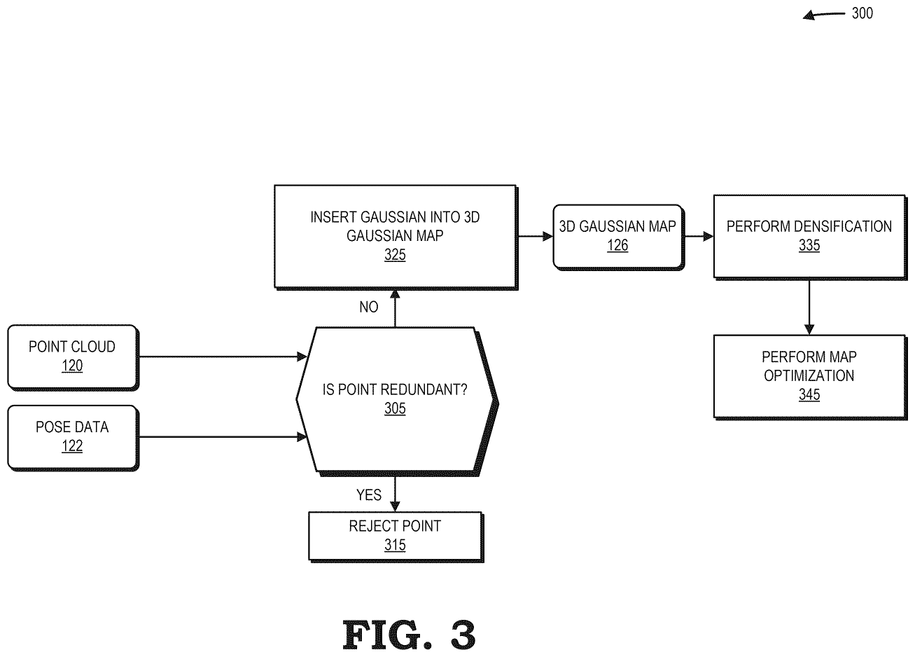

Referring now to FIG. 3, an example operation 300 for updating a 3D Gaussian map based on RGB frames is presented, in accordance with implementations. According to implementations, example operation 300 occurs after a 3D Gaussian map 128 has been initialized and is implemented at least in part by processor 102, AU 110, or both. In implementations, at block 305, example operation 300 includes a Gaussian mapping model 124 receiving a point cloud 120 and pose data 122 generated from one or more RGB frames 114. For example, after a 3D Gaussian Map 124 has been initialized, one or more RGB frames 114 are provided to VO tracking model 118. Based on these RGB frames 114, processor 102, implementing the VO tracking model 118, generates a point cloud 120 representing the positions of the centers of patches 235 that are common within two or more of these RGB frames 114 and pose data 122 representing the position and orientation of the capture device 108 within the RGB frames 114 (e.g., the location of the capture device 108 within the environment represented by the RGB frames 114). Still referring to block 305, in response to receiving the point cloud 120, pose data 122, or both, processor 102 is configured to determine whether each point (e.g., patch 235) indicated in the point cloud 120 is redundant. For example, processor 102 first determines the respective distances between a point indicated in the point cloud 120 to the means (e.g., center points) of Gaussians 275 in the 3D Gaussian map 126. Based on the respective distance between a point indicated in the point cloud 120 and the mean of each Gaussian 275 in the 3D Gaussian map 126 not exceeding a predetermined threshold value, processor 102 determines that the point is redundant and moves to block 315. At block 315, processor 102 rejects the point such that processor 102 does not generate a Gaussian 275 based on the point. Further, referring again to block 305, based on the respective distance between a point indicated in the point cloud 120 and the mean of one or more Gaussians 275 in the 3D Gaussian map 126 being equal to or greater than a predetermined threshold value, processor 102 determines that the point is not redundant and moves to block 325. At block 325, Gaussian mapping model 124 back projects the point and generates a corresponding Gaussian 275 based on the back-projected point. After generating this Gaussian 275, processor 102 inserts the Gaussian 275 into the 3D Gaussian map 126.

In implementations, at block 335, processor 102 is configured to perform a densification operation on 3D Gaussian map 126. According to implementations, block 335 includes processor 102 performing a densification operation on an initialized 3D Gaussian map (e.g., initialized 3D Gaussian map 285), a 3D Gaussian map 126 updated at block 325, or both. At block 335, processor 102 is configured to determine a pixel rendering gradient for each Gaussian 275 in the 3D Gaussian map 126 based on the RGB values indicated by the Gaussian 275. Based on the pixel rendering gradient for a Gaussian 275 being equal to or exceeding a predetermined threshold value, processor 102 splits or clones the Gaussian 275 within the 3D Gaussian map 126. As an example, based on the 3D scale of a Gaussian 275, processor 102 splits or clones the Gaussian 275 in response to the pixel rendering gradient for a Gaussian 275 being equal to or exceeding a predetermined threshold value. Further, at block 345, processor 102 is configured to optimize 3D Gaussian map 126 by performing a planar regulation operation. According to implementations, block 345 includes processor 102 performing a densification operation on an initialized 3D Gaussian map (e.g., initialized 3D Gaussian map 285), a 3D Gaussian map 126 updated at block 325, or both. At block 345, processor 102 first generates a rendered frame 128 based on the 3D Gaussian map 126. For example, processor 102 alpha-blends the RGB values 116 and transparencies of Gaussians 275 in the 3D Gaussian map 126 at each pixel represented by the 3D Gaussian map 126 to generate a rendered frame 128. Processor 102 then compares this rendered frame 128 to a corresponding RGB frame 114 input to the VO tracking model 118 (e.g., an RGB frame 114 representing the same scene as the rendered frame 128). For example, based on a comparison of the rendered frame 128 and corresponding RGB frame 114, processor 102 determines a loss value based on the standard photometric loss between the frames. According to implementations, processor 102 determines this loss value according to the following equations:

$${L}_{color} = ( 1 - {λ}_{photo} ) * {L}_{photo} ( {\hat{I}}_{i} , {I}_{i} ) + {λ}_{photo} * {L}_{SSIM} ( {\hat{I}}_{i} , {I}_{i} ) , \qquad [ EQ 6 ]$$

$${L}_{reg} = \vert max ( . 01 , min ( s ) ) \vert$$

$$L = {λ}_{color} * {L}_{color} + {λ}_{reg} * {L}_{reg} \qquad [ EQ 7 ]$$

wherein L_{color} represents standard photometric loss, λ_photo represents a predetermined weighting parameter, Lₚₕₒₜₒ represents photometric loss, Î represents the rendered frame 128, I represents a corresponding RGB frame 114, L_{SSIM} represents a structural similarity index measure, and L_{reg} represents a planar regularization term. After determining a loss value based on a comparison of the rendered frame 128 and corresponding RGB frame 114, processor 102 is configured to modify one or more parameters of the Gaussians 275 in the 3D Gaussian map 126 so as to reduce the loss value. In this way, processor 102 is configured to help improve the accuracy of a resulting 3D Gaussian map 126.

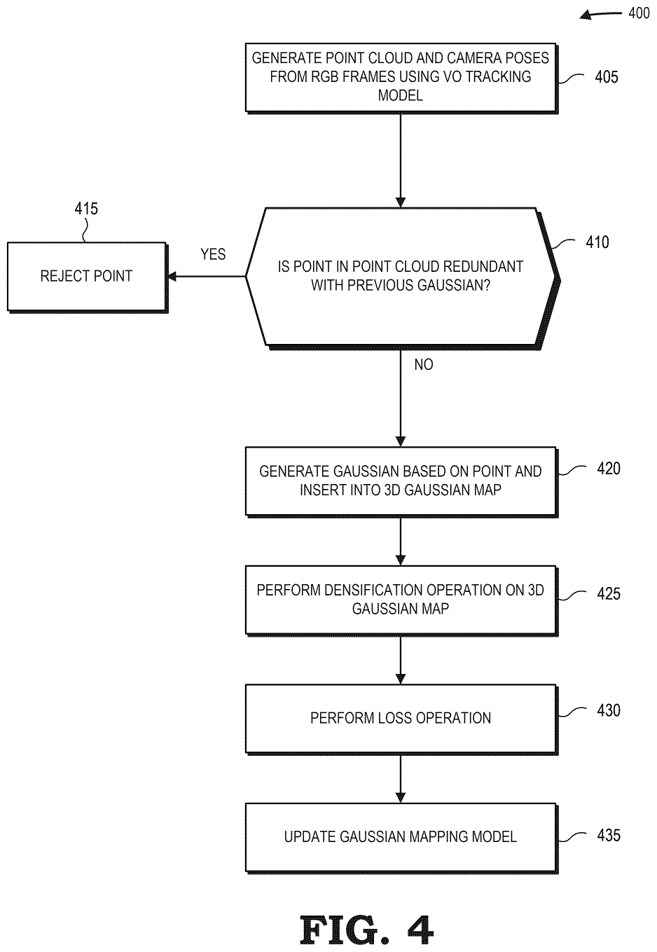

Referring now to FIG. 4, an example method 400 for implementing a Gaussian SLAM operation based on an RGB frame is presented, in accordance with implementations. In implementations, example method 400 is implemented at least in part by processor 102, AU 110, or both. At block 405 of example method 400, the VO tracking model 118 is configured to receive a number of RGB frames 114 as an input. To then implement VO tracking model 118, processor 102 is configured to determine pose data 122 for each input RGB frame 114 with such pose data 122 indicating the position and orientation of the capture device 108 within the scene represented by the RGB frames 114. Processor 102 then samples a predetermined number of patches 235 from each RGB frame 114 received as an input. Processor 102 then parameterizes these sampled patches 235 such that the patches 235 each indicate a corresponding location within a respective RGB frame 114 and a corresponding inverse depth 245. From these patches 235, processor 102 generates a patch graph 255 that includes edges indicating the trajectories of the patches 235 between two or more RGB frames 114 received as inputs. Processor 102 then generates a point cloud 120 indicating the positions of the centers of the patches 235 based on the patch graph 255 and the pose data 122.

At block 410, processor 102 is configured to determine whether each point in the point cloud 120 is redundant when compared to the Gaussians 275 in a 3D Gaussian map 126. For example, for each point in the point cloud 120, processor 102 determines the distance from the point and each mean (e.g., center point) of the Gaussians 275 in the 3D Gaussian map 126. Based on the distance between the point and the mean of each Gaussian not exceeding a predetermined threshold, processor 102, at block 415, determines that the point is redundant. Further, at block 415, processor 102 rejects the point such that processor 102 does not generate a corresponding Gaussian 275 for the point. Referring again to block 410, based on the distance between the point and the means of one or more Gaussians meeting or exceeding the predetermined threshold, processor 102, at block 420, processor provides the point to the Gaussian mapping model 124. To implement the Gaussian mapping model 124, processor 102 first back-projects the point so as to generate a point in a world coordinate system. Based on this point in the world coordinate system and the RGB values 116 represented by the patch 235 associated with the point, processor 102 generates a Gaussian 275 indicating a position within the world coordinate system, a covariance, one or more RGB values, orientation, 3D scale, and a transparency. After generating this Gaussian 275, processor 102 inserts the Gaussian 275 into 3D Gaussian map 126. According to implementations, After processor 102 has inserted one or more Gaussians 275 into 3D Gaussian map 126, processor 102, at block 425, is configured to perform a densification operation on 3D Gaussian map 126. As an example, to perform the densification operation, processor 102 determines a pixel rendering gradient for each Gaussian 275 in the 3D Gaussian map 126 based on the RGB values indicated by the Gaussians 275. In response to the pixel rendering gradient for a Gaussian 275 being equal to or exceeding a predetermined threshold value, processor 102 splits or clones the Gaussian 275 within the 3D Gaussian map 126 based on the 3D scale of a Gaussian 275.

At block 430, processor 102 is configured to tune the Gaussian mapping model 124. For example, processor 102 is configured to modify one or more parameters of the Gaussian mapping model 124 based on a planar regulation operation. During this planar regulation operation, processor 102 is configured to generate a rendered frame 128 based on the 3D Gaussian map 126. As an example, processor 102 alpha-blends the RGB values 116 and transparencies of Gaussians 275 in the 3D Gaussian map 126 at each pixel represented by the 3D Gaussian map 126 to generate a rendered frame 128. Processor 102 then compares this rendered frame 128 to a corresponding RGB frame 114 input to the VO tracking model 118. Based on this comparison, processor 102 determines a loss value based on the standard photometric loss between the frames. At block 435, processor 102 then modifies one or more parameters of the Gaussians 275 in the 3D Gaussian map 126 so as to reduce the determined loss value.

In some implementations, the apparatus and techniques described above are implemented in a system including one or more integrated circuit (IC) devices (also referred to as integrated circuit packages or microchips), such as the processor described above with reference to FIGS. 1-4. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory) or coupled to the computer system via a wired or wireless network (e.g., network accessible storage (NAS)).

In some implementations, certain aspects of the techniques described above may be implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific implementations. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific implementations. However, the benefits, advantages, solutions to problems, and any feature(s) that may cause any benefit, advantage, or solution to occur or become more pronounced are not to be construed as a critical, required, or essential feature of any or all the claims. Moreover, the particular implementations disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular implementations disclosed above may be altered or modified and all such variations are considered within the scope of the disclosed subject matter. Accordingly, the protection sought herein is set forth in the claims below.

What is claimed is:

1. A processing system, comprising:
a storage device configured to store a plurality of frames, wherein each frame of the plurality of frames is representative of an environment; and
a processor configured to:
sample, by a visual odometry (VO) tracking model, a plurality of patches from the plurality of frames;
determine, by a Gaussian mapping model, a set of Gaussians based on the plurality of patches; and
populate a three-dimensional (3D) Gaussian map representing the environment with one or more Gaussians of the set of Gaussians.

2. The processing system of claim 1, wherein the processor is further configured to:
generate a patch graph based on the plurality of patches, wherein the patch graph indicates a trajectory of one or more patches of the plurality of patches between two or more frames of the plurality of frames.

3. The processing system of claim 2, wherein the processor is further configured to:
generate a point cloud based on the patch graph;
back-project a patch to produce a back-projected point; and
determine a Gaussian of the set of Gaussians based on the back-projected point.

4. The processing system of claim 3, wherein the processor is further configured to:
reject a second point of the point cloud based on a respective distance between the second point and each Gaussian of the 3D Gaussian map not exceeding a threshold.

5. The processing system of claim 1, wherein the processor is further configured to:
perform a densification operation on the 3D Gaussian map.

6. The processing system of claim 1, wherein the processor is further configured to:
generate a rendered frame based on the 3D Gaussian map; and
modify one or more parameters of the 3D Gaussian map based on a comparison of the rendered frame to a frame of the plurality of frames.

7. The processing system of claim 1, further comprising:
an accelerator unit configured to execute one or more instructions for the Gaussian mapping model.

8. A method, comprising:
receiving a plurality of frames captured by a capture device, wherein each frame of the plurality of frames is representative of an environment;
sampling, by a visual odometry (VO) tracking model, a plurality of patches from the plurality of frames;
determining, by a Gaussian mapping model, a set of Gaussians based on the plurality of patches; and
populating a three-dimensional (3D) Gaussian map representing the environment with one or more Gaussians of the set of Gaussians.

9. The method of claim 8, further comprising:
generating a patch graph based on the plurality of patches, wherein the patch graph indicates a trajectory of one or more patches of the plurality of patches between two or more frames of the plurality of frames.

10. The method of claim 9, further comprising:
generating a point cloud based on the patch graph;
back-projecting a patch to produce a back-projected point; and
determining a Gaussian of the set of Gaussians based on the back-projected point.

11. The method of claim 10, further comprising:
rejecting a second point from the point cloud based on a respective distance between the second point and each Gaussian of the 3D Gaussian map not exceeding a threshold.

12. The method of claim 8, further comprising:
performing a densification operation on the 3D Gaussian map.

13. The method of claim 8, further comprising:
generating a rendered frame based on the 3D Gaussian map; and
modifying one or more parameters of the 3D Gaussian map based on a comparison of the rendered frame to a frame of the plurality of frames.

14. The method of claim 8, wherein each patch of the plurality of patches indicates:
a location in a corresponding frame of the plurality of frames; and
an inverse depth.

15. A device comprising:
one or more processor cores configured to:
sample a plurality of patches from a plurality of frames captured by a capture device, wherein each frame of the plurality of frames is representative of an environment;
parameterize the plurality of patches such that each patch of the plurality of patches indicates an inverse depth; and
generate, by a Gaussian mapping model, a three-dimensional (3D) Gaussian map representing the environment based on the plurality of parameterized patches.

16. The device of claim 15, wherein the one or more processor cores are further configured to:
generate a patch graph based on the plurality of parameterized patches, wherein the patch graph indicates a trajectory of one or more patches of the plurality of patches between two or more frames of the plurality of frames.

17. The device of claim 16, wherein the one or more processor cores are further configured to:
generate a point cloud based on the patch graph;
back-project a patch to produce a back-projected point; and
determine a Gaussian of the 3D Gaussian map based on the back-projected point.

18. The device of claim 17, wherein the one or more processor cores are further configured to:
reject a second point of the point cloud based on a respective distance between the second point and each Gaussian of the 3D Gaussian map not exceeding a threshold.

19. The device of claim 15, wherein the one or more processor cores are further configured to:
perform a densification operation on the 3D Gaussian map.

20. The device of claim 15, wherein the one or more processor cores are further configured to:
generate a rendered frame based on the 3D Gaussian map; and
modify one or more parameters of the 3D Gaussian map based on a comparison of the rendered frame to a frame of the plurality of frames.
